(19) United States
(12) Patent Application Publication
(10) Pub. No.: US 2015/0057582 A1
(43) Pub. Date: Feb. 26, 2015

(54) FINGER-HELD MASSAGE APPARATUS

(71) Applicants: Andrew P. Morrison, San Francisco, CA (US); Tylor Hilton Garland, Studio City, CA (US)

(72) Inventors: Andrew P. Morrison, San Francisco, CA (US); Tylor Hilton Garland, Studio City, CA (US)

(21) Appl. No.: 14/467,666

(22) Filed: Aug. 25, 2014

Related U.S. Application Data
(60) Provisional application No. 61/869,104, filed on Aug. 23, 2013.

(51) Int. Cl. A61H 23/00

(52) U.S. Cl. CPC A61H 23/00
USPC 601/46

(57) ABSTRACT

A finger-held massage apparatus is described and includes an inverted U-shaped element composed of a U-shaped bridge with a pair of legs in spaced relation from one another and extending from the bridge, with lower ends of the legs configured to have opposed first pockets on leg inner surfaces thereof and second pockets on leg outer surfaces thereof. Each leg inner surface includes a first pocket integrally-formed therein, one first pocket in opposed facing relation with the other on the opposite leg inner surface, each first pocket being configured to hold a vibrating massage element therein. Each leg outer surface includes a second pocket integrally-formed into the leg outer surface, one second pocket configured to receive a thumb therein and the other second pocket a finger of a human hand therein for manipulation of the massage apparatus with the vibrating massage elements therein.

### CROSS-REFERENCE TO RELATED APPLICATION

The present application claims the benefit under 35 U.S.C. §119(e) of U.S. Provisional Patent Application No. 61/869,104, filed Aug. 23, 2013, the entire contents of which is hereby incorporated by reference herein.

### BACKGROUND

1. Field

Example embodiments in general relate to a finger-held massage apparatus.

2. Related Art

Many devices have been developed to enable a massage by the fingers. One such device incorporates the fingers into dedicated ports or pods that enable the fingers to manipulate the pods while massaging an area of the body. Another device employs vibration to stimulate the finger itself, rendering a massage to the finger. Several types of devices are held by one or more fingers and have implements thereon that are used in the massaging process, rather than the fingers themselves. Also prevalent are many different types of hand-held vibratory massagers that are designed to stimulate areas of the body. Further, there is even a device that is designed to simulate finger action in massaging a part of the body.

### SUMMARY

An example embodiment is directed to a finger-held massage apparatus. The apparatus includes an inverted U-shaped element composed of a U-shaped bridge with a pair of legs in spaced relation from one another and extending from the bridge, with lower ends of the legs configured to have opposed first pockets on leg inner surfaces thereof and second pockets on leg outer surfaces thereof. Each leg inner surface includes a first pocket integrally-formed into the leg inner surface and in opposed facing relation with a corresponding first pocket on the opposite leg inner surface, each first pocket being configured to hold a vibrating massage element therein. Each leg outer surface on either side of the inverted U-shaped element includes a second pocket integrally-formed into the leg outer surface, one second pocket configured to receive a thumb therein and the other second pocket a finger of a human hand therein for manipulation of the massage apparatus with the vibrating massage elements therein.

### BRIEF DESCRIPTION OF THE DRAWINGS

Example embodiments will become more fully understood from the detailed description given herein below and the accompanying drawing, wherein like elements are represented by like reference numerals, which are given by way of illustration only and thus are not limitative of the example embodiments herein.

FIG. 1 is a perspective view of a finger-held massage apparatus according to an example embodiment.

FIG. 2 is a front view of the vibrating massage element usable in the apparatus of FIG. 1.

FIG. 3 is an exploded view of the finger-held massage apparatus.

FIG. 4 is a front view of the finger-held massage apparatus showing operation thereof.

### DETAILED DESCRIPTION

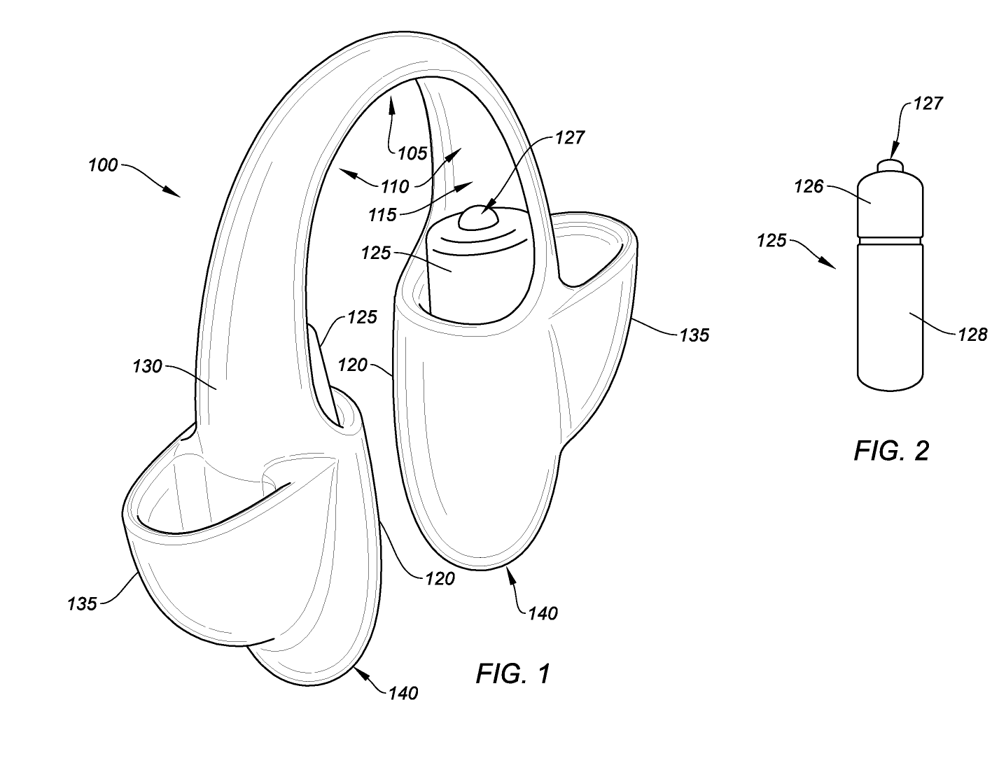

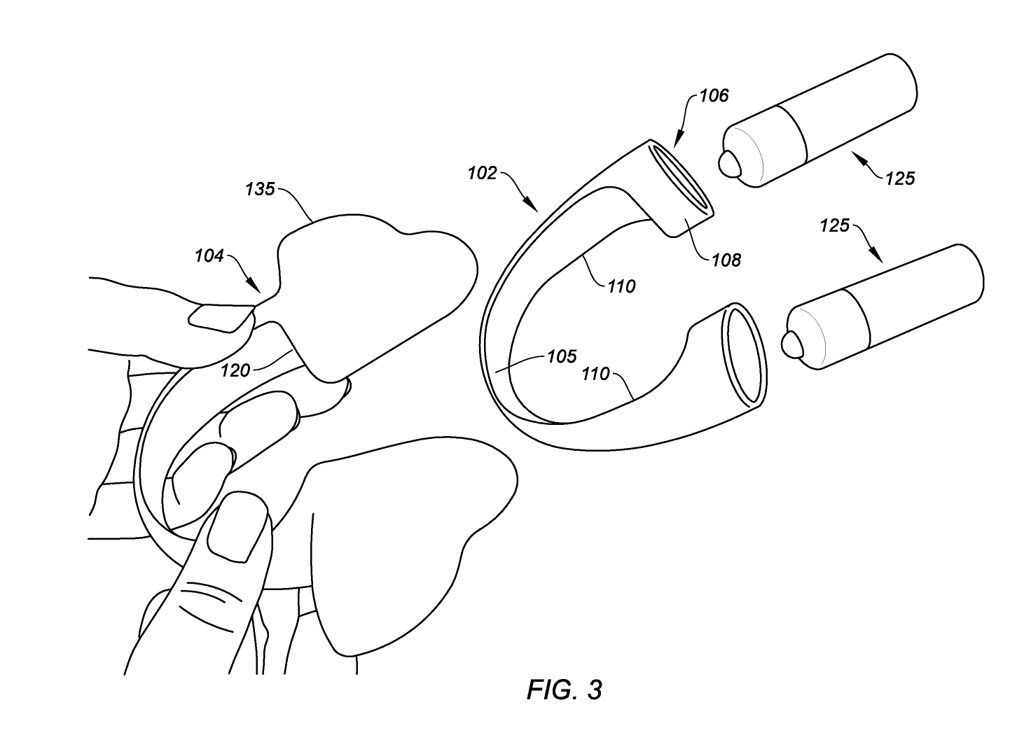

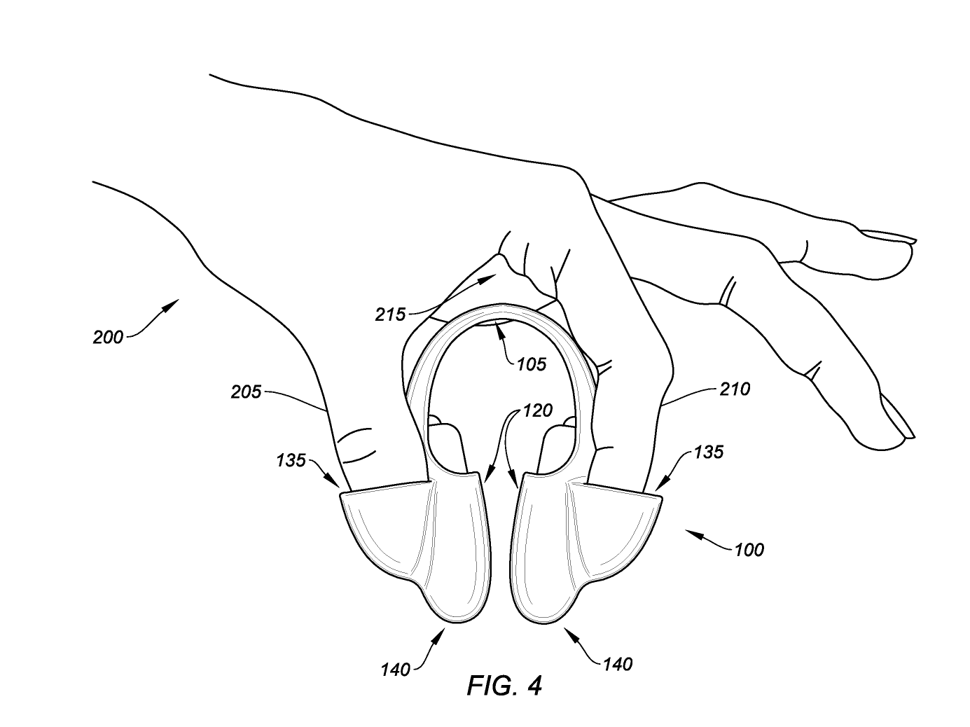

FIG. 1 is a perspective view of a finger-held massage apparatus according to an example embodiment; FIG. 2 is a front view of the vibrating massage element usable in the apparatus of FIG. 1; FIG. 3 is an exploded parts view of the apparatus; and FIG. 4 is a front view of the finger-held massage apparatus showing operation thereof. Referring to FIGS. 1-4, a finger-held massage apparatus 100 (“apparatus 100”) includes an inverted U-shaped element 105 or a U-shaped “bridge” that extends to an integral pair of legs 110 in spaced relation to one another. Each leg 110 has a leg inner surface 115 and a leg outer surface 130.

The lower ends of each leg 110 terminate into first (inner) and second (outer) pockets 120, 135, respectively. Specifically referring to FIG. 1, each leg inner surface 115 includes a first pocket 120 integrally-formed into its leg inner surface 115 and in opposed facing relation with a corresponding first pocket 120 integrally-formed into the opposite leg inner surface 115. Each first pocket 120 is configured to hold a vibrating massage element 125 therein. Each leg outer surface 130 on either side of the inverted U-shaped element 105 includes a second pocket 135 that is integrally-formed as part of its corresponding leg outer surface 130. As shown in FIG. 4, one of the second pockets 135 is configured to receive a thumb 205 therein, and the other second pocket 135 a finger 210 of a human hand 200 therein for manipulation of the massage apparatus 100 with the vibrating massage elements 125 therein. The outer surfaces at the bottom of the first pockets 120 serve as touch points 140 for the apparatus 100; these touch points 140 are what will contact a part of the body to provide massage relief, under the vibratory action of the vibrating massage elements 125 within first pockets 120.

Referring to FIG. 3, apparatus 100 is composed of a hard plastic core member 102 or inner layer which forms the inverted U-shaped bridge 105 and legs 110 of the apparatus 100. The core member 102 terminates at its bottom into two circular openings 106 with walls 108 that are designed as resilient guides for the vibrating massage elements 125 within the first pockets 120, and also to provide structure for the first pockets 120. This core member 102 is wrapped or covered by a softer, removable silicon member 104 or outer layer that outlines the U-shaped bridge 105 and legs 110 of the core member 102 when attached, and which terminates at its bottom as the pockets 120, 135. Specifically, the walls 108 of the core member 102 are inserted into the first pockets 120 after the silicon member 104 is pulled over and around the core member 102, so that silicon member 104 is stretched over the U-shaped element 105 and integral legs 110 of the core member 102. Thus, the two members 102, 104 can be separated by hand for washing after use.

Referring to FIG. 2, the vibrating massage element 125 includes a top section 126 that is removable from a bottom section 128 by turning the top section 126 in a counter-clockwise manner to access a power source (not shown) within. In an example, the power source may be three (3) LR44 button cell batteries; although other types of battery cells are contemplated. The vibrating massage element 125 includes a clicking on/off power button 127 at a top end thereof.

Referring to FIG. 4, in operation a user places their thumb and index finger (or middle finger) in the second pockets 135, with the U-shaped bridge 105 resting just inside or outside of their hand, depending on what is more comfortable. The user then may turn on both vibrating massage elements 125 by firmly pushing down on the on/off button 127 of each until they hear a “click”. When they release the button 127 the massage element 125 begins to vibrate. The user may then employ the apparatus 100 as desired for massage of a part of the body.

### EXAMPLES

Minute Massage—Head, Neck and Chest. Hold the apparatus 100 as described above, with the massage elements 125 energized. Spread the twin touch points 140 approximately 3 to 4 inches apart and firmly press on the inner sides of the temples. Hold for 5 seconds. Next, move apparatus 100 to the underside of the eyebrows, spreading the twin touch points 140 approximately 2 inches wide. Press firmly for another 5 seconds.

Move apparatus 100 to the middle of the nose, spreading the twin touch points 140 1 inch apart so that they touch both sides of the nose. Press firmly for 5 seconds. Then move them down to the upper lip so that they touch just inside the outer edge of the lips. Press firmly for 5 seconds.

Now move to the middle of the chin just below the lips, squeezing the twin touch points 140 together so there's no space between them. Press firmly for 10 seconds. Next, move device 100 to the upper chest and find the top of the collarbone. With the twin touch points 140 spread about 3 inches apart, press firmly for 10 seconds. Then, move to the back of the neck, spreading the twin touch points 140 extra wide so that they are 4 to 5 inches apart. Find the back base of each ear and press firmly for 20 seconds. Repeat as desired.

Foot massage: Hold apparatus 100 with thumb and index finger (or middle finger) in the second pockets 135, with the bridge 105 resting just inside or outside of their hand, depending on what is more comfortable, and with massage elements 125 energized. Spread the twin touch points 140 apart from one another approximately 1 inch apart. Starting at the back of the calf, press firmly upon travelling down the ankle and the outer sides of the Achilles. Repeat two more times, or for approximately 10 seconds. Next, move to the heel and press the twin touch points 140 together, so there's no space between them. Press firmly against the bottom of the foot, moving from heel to toe. Do these several times, or for about 20 seconds. Repeat the whole process on the other calf, ankle and foot.

The example embodiments being thus described, it will be obvious that the same may be varied in many ways. Such variations are not to be regarded as departure from the example embodiments, and all such modifications as would be obvious to one skilled in the art are intended to be included in the following claims.

We claim:

1. A finger-held massage apparatus, comprising:
an inverted U-shaped element composed of a U-shaped bridge with a pair of legs in spaced relation from one another and extending from the bridge, with lower ends of the legs configured to have opposed first pockets on leg inner surfaces thereof and second pockets on leg outer surfaces thereof,
wherein each first pocket is integrally-formed into its corresponding leg inner surface and in opposed facing relation with the other first pocket on the opposite leg inner surface, each first pocket configured to hold a vibrating massaging element therein, and
wherein each second pocket is integrally-formed into its corresponding leg outer surface on either side of the inverted U-shaped element, one of the second pockets configured to receive a corresponding thumb therein and the other second pocket a finger of a human hand therein for manipulation of the massage apparatus with vibrating massage elements therein.

2. The apparatus of claim 1, wherein the first and second pockets are composed of silicone.

3. The apparatus of claim 1, wherein the U-shaped element is formed of an outer layer of silicone which extends over to cover an inner layer of a harder plastic that forms the inverted U-shaped bridge and legs.
